(19) United States
(12) Patent Application Publication
(10) Pub. No.: US 2016/0014540 A1
(43) Pub. Date: Jan. 14, 2016

(54) SOUNDBAR AUDIO CONTENT CONTROL USING IMAGE ANALYSIS

(71) Applicant: Imagination Technologies Limited, Kings Langley (GB)

(72) Inventors: Alan Kelly, Berkhamsted (GB); Hossein Yassaie, Little Chalfont (GB)

(21) Appl. No.: 14/794,565

(22) Filed: Jul. 8, 2015

(30) Foreign Application Priority Data
Jul. 8, 2014 (GB) 1412117.2

(51) Int. Cl. H04S 7/00; H04R 5/04; G06F 3/01; H04N 7/18

(52) U.S. Cl. CPC H04S 7/303; H04N 7/183; H04R 5/04; G06F 3/013

(57) ABSTRACT

A soundbar is described which includes a camera. The camera can be used to capture images of a listener as speakers of the soundbar output audio content to the listener. The captured images can be analysed to determine at least one characteristic of the listener (e.g. the age or gender of the listener). In one example, when the soundbar has determined a characteristic of the listener, the audio content outputted to the listener may be controlled based on the characteristic. In other examples, the images of the listener captured by the camera may be used to detect a response of the listener to media content which includes the audio content outputted from the soundbar. This response information may be combined with an indication of the characteristic of the listener in order to gather information relating to how different types of listeners respond to particular media content.

### BACKGROUND

Speaker systems include one or more speakers for outputting sounds represented by audio signals to a listener to thereby deliver audio content to the listener. The audio content could for example be music or speech or other sound data that is to be delivered to the listener. There are many types of speaker system available. In the simplest case, a single speaker outputs a single audio wave which can thereby provide mono audio content to the listener. In another case, two speakers can be used to output audio content in stereo, whereby the different speakers output different signals in order to provide the audio content to the listener in stereo, which can create the impression of directionality and audible perspective for the listener. A surround sound system is a more complex case which uses multiple speakers (e.g. between three and fifteen speakers) located so as to surround the listener and to provide sound from multiple directions. Different audio channels are routed to different ones of the speakers so as to create the impression of sound spatialization for the listener. Surround sound is characterized by an optimal listener location (or “sweet spot”) where the audio effects work best. There are different surround sound formats which have different numbers and/or speaker positions for the different audio channels. For example, a 5.1 surround system comprises six audio channels including five full bandwidth channels and one lower bandwidth (or bass) channel which provides low-frequency effects. In particular, a 5.1 surround sound system comprises a configuration of speakers having a front left speaker, a front right speaker, a front centre speaker, a rear right speaker, a rear left speaker and a subwoofer.

Surround sound systems are good at creating the impression of a 3D sound field for a listener. However, surround sound systems are not always convenient to install, e.g. in a home. It is often the case that the speakers (in particular the rear speakers) are not placed in the optimum position due to the physical constraints of the room in which the system is implemented. For example, furniture or walls or other objects may obstruct the optimum positioning of the speakers. Furthermore, typically, each speaker is connected using a wire which can be inconvenient (particularly for the rear speakers).

A so-called soundbar is usually a more convenient solution than a full surround sound system, and can provide a reasonable impression of sound spatialization for the listener. A soundbar has a speaker enclosure including multiple speakers to thereby provide reasonable stereo and other audio spatialization effects. Soundbars are usually much wider than they are tall and usually have the multiple speakers arranged in a line, horizontally. This speaker arrangement is partly to aid the production of spatialized sound, but also so that the soundbar can be positioned conveniently above or below a display, e.g. above or below a television or computer screen. The quality of sound provided by soundbars has improved in the last few years, and due to the convenience of installing a soundbar (compared to installing a full surround sound system) soundbars are rapidly becoming more popular for use in the home.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In examples described herein, a camera is included in a soundbar. The camera can be used to capture images of a listener as speakers of the soundbar output audio content to the listener. The captured images can be analysed to determine at least one characteristic of the listener (e.g. the age or gender of the listener). Furthermore, video content may be routed via the soundbar, e.g. the soundbar may receive media content (including both audio and video content) from a content source and may output the audio content whilst passing the video content on to a display such that the audio and video content can be outputted concurrently. In one example, when the soundbar has determined a characteristic of the listener, the audio content and/or video content (in the case that video content is passed via the soundbar) outputted to the listener may be controlled based on the characteristic. For example, if the listener is identified as being a child, then only age-appropriate audio and/or video content may be outputted to the listener. As another example, the determined characteristic (e.g. age and/or gender) of the listener may be used to tailor advertisements to the particular listener. In other examples, the images of the listener captured by the camera may be used to detect a response of the listener to media content which includes the outputted audio and/or video content. The response information may be combined with an indication of the characteristic of the listener in order to gather information relating to how different types of listeners respond to particular media content. This may be useful for media content such as advertisements or entertainment programmes.

In particular, there is provided a soundbar comprising: a plurality of speakers configured to output audio content to a listener; a camera configured to capture images of the listener; and processing logic configured to: (i) analyse the captured images to determine at least one characteristic of the listener; and (ii) control the audio content outputted from the speakers to the listener based on the determined at least one characteristic of the listener.

There is also provided a method of operating a soundbar comprising: outputting audio content to a listener from a plurality of speakers of the soundbar; capturing images of the listener using a camera; analysing the captured images to determine at least one characteristic of the listener; and controlling the audio content outputted from the speakers of the soundbar to the listener based on the determined at least one characteristic of the listener.

There is also provided a soundbar comprising: a plurality of speakers configured to output audio content to a listener; a camera configured to capture images of the listener; and processing logic configured to analyse the captured images to determine at least one characteristic of the listener and to detect a response of the listener to media content which includes audio content outputted from the speakers.

There is also provided a method of operating a soundbar comprising: outputting audio content to a listener from a plurality of speakers of the soundbar; capturing images of the listener using a camera; analysing the captured images to determine at least one characteristic of the listener and to detect a response of the listener to media content which includes the audio content outputted from the speakers.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 represents an environment including a media system and two listeners;

FIG. 2 shows a schematic diagram of a soundbar in the media system;

FIG. 3 is a flow chart for a first method of operating a soundbar;

FIG. 4 is a flow chart for a second method of operating a soundbar; and

FIG. 5 shows a schematic diagram of a soundbar in another example.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

Embodiments will now be described by way of example only.

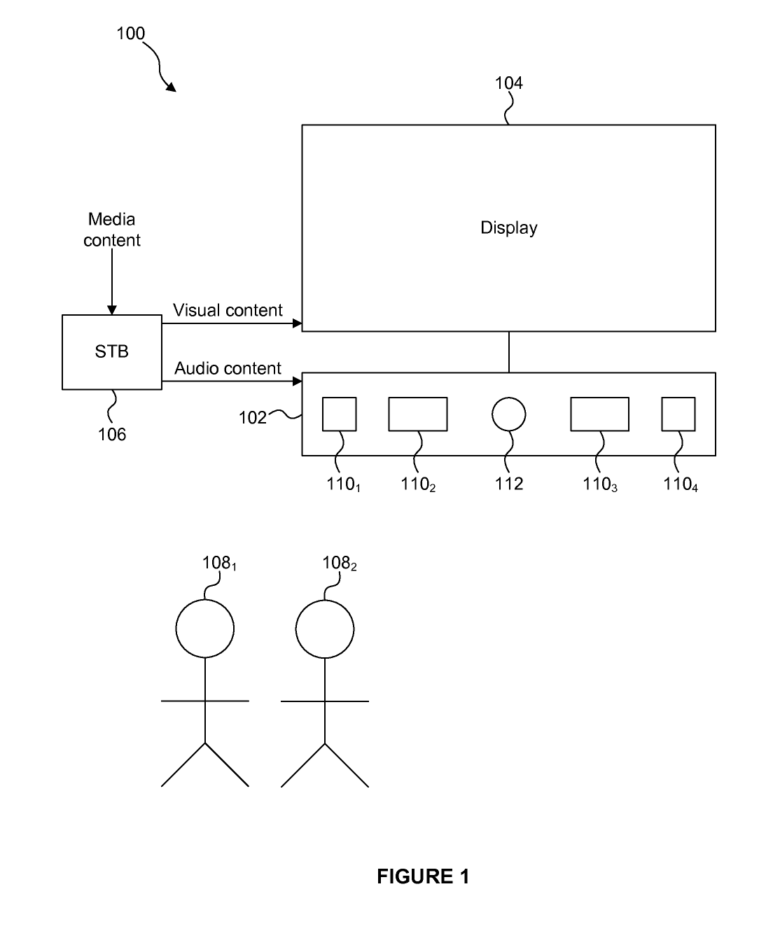

FIG. 1 shows an environment 100 including a media system which comprises a soundbar 102, a display 104 and a set top box (STB) 106, and two listeners 108₁ and 108₂. The soundbar 102 comprises four speakers 110₁, 110₂, 110₃ and 110₄, and a camera 112. In some examples a soundbar may include more than one camera. The soundbar 102 is positioned below the display 104, which is for example a television or a computer screen. In this example, the listeners 108 are listeners of audio content outputted from the soundbar 102 and are also viewers of visual content outputted from the display 104. In this system, the STB 106 receives media content which includes both visual content (which may also be referred to herein as “video content”) and audio content, e.g. via a television broadcast signal or over the internet. The visual content is provided from the STB 106 to the display 104 and the audio content is provided from the STB 106 to the soundbar 102. In other examples, all of the media content (i.e. the visual and audio content) may be provided to the display 104 and then the audio content is passed from the display 104 to the soundbar 102. In some examples (which are different to the example shown in FIG. 1), both the visual and audio content may be routed via the soundbar 102. That is, the STB 106 may provide both the visual and audio content to the soundbar 102 and the soundbar 102 separates the audio content from the visual content such that the visual content can be passed to the display 104. In these examples, the soundbar 102 outputs the audio content while the display 104 concurrently outputs the corresponding visual content. In examples in which the visual content is routed via the soundbar 102, the soundbar 102 may be able to control the visual content before passing it on to the display 104. In other examples, the visual and audio content may be received at the display 104 and at the soundbar 102 from a different source (i.e. not from the STB 106), for example from a video streaming device or media player such as from a computer, laptop, tablet, smartphone, digital media player, TV receiver or streamed from the internet. FIG. 1 shows a situation in which two listeners 108₁ and 108₂ are present, but in other examples any number of listeners may be present, e.g. one or more listeners may be present.

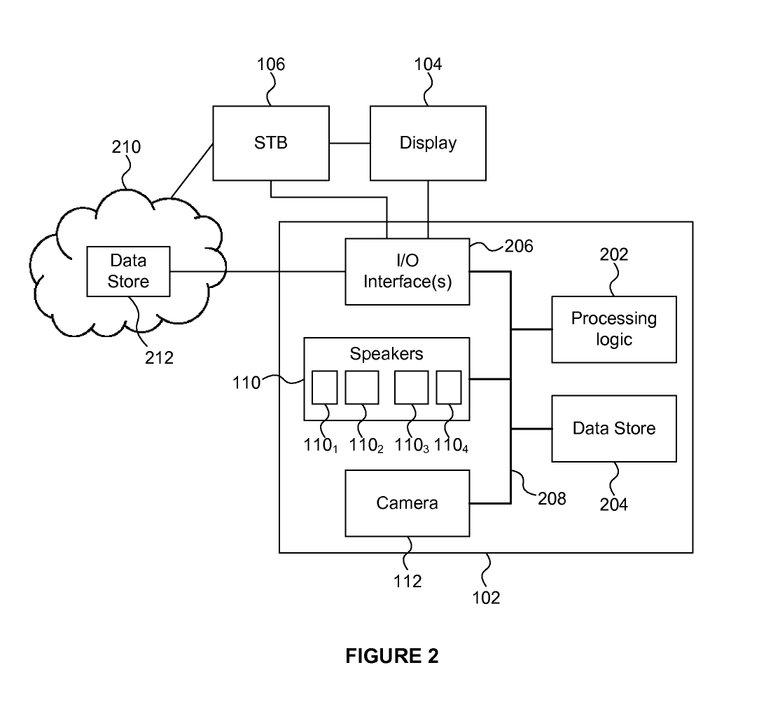

FIG. 2 shows a schematic view of some of the components of the soundbar 102. The soundbar 102 comprises the speakers 110, the camera 112, processing logic 202, a data store 204 and one or more Input/Output (I/O) interfaces 206 for communicating with other elements of the media system. The speakers 110, camera 112, processing logic 202, data store 204 and I/O interface(s) 206 are connected to each other via a communication bus 208. The I/O interfaces 206 may comprise an interface for communicating with the display 104, an interface for communicating with the STB 106 and an interface for communicating over the internet 210, e.g. to transfer data between the soundbar 102 and a remote data store 212 in the internet 210. The connections between the soundbar 102, the display 104, the STB 106 and the internet 210 may be wired or wireless connections according to any suitable type of connection protocol. The processing logic 202 controls the operation of the soundbar 102, for example to control the outputting of audio content from the speakers 110, to analyse images captured by the camera 112 and/or to store data in the data store 204. In examples in which the video content is routed via the soundbar 102 then the processing logic 202 may control the video content which is passed on to the display 104. The processing logic 202 may be implemented in hardware, software, firmware or any combination thereof. For example, if the processing logic 202 is implemented in hardware then the functionality of the processing logic 202 may be implemented as fixed function circuitry comprising transistors and other suitable hardware components arranged so as to perform particular operations. As another example, if the processing logic 202 is implemented in software then it may take the form of computer program code (e.g. in any suitable computer-readable programming language) which can be stored in a memory (e.g. in the data store 204) such that when the code is executed on a processing unit (e.g. a Central Processing Unit (CPU)) it can cause the processing unit to carry out the functionality of the processing logic 202 as described herein.

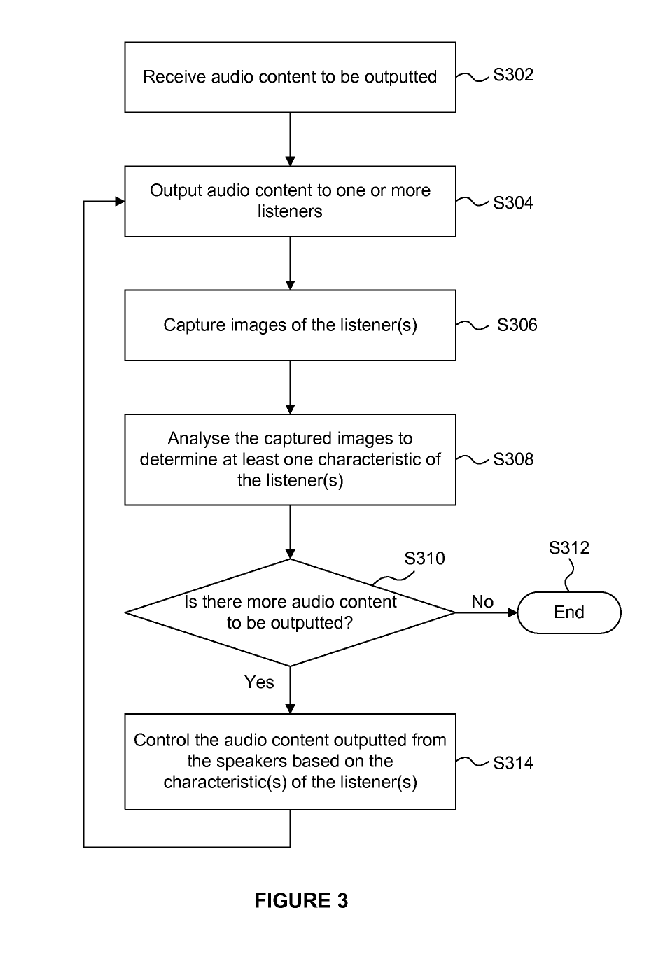

With reference to the flow chart shown in FIG. 3 there is now described a first method of operating the soundbar 102. In step S302 audio content is received at the soundbar 102 which is to be outputted from the speakers 110 of the soundbar 102. The audio content may be received, from the STB 106, at the I/O interface 206. The audio content may be received at the soundbar 102 to be outputted in conjunction with visual content outputted from the display 104. As described above, in some examples, the audio and visual content are both received at the soundbar 102 from the STB 106 and the visual content is separated from the audio content and passed on to the display 104.

In step S304 the audio content is outputted from the speakers 110 to the listener(s) 108.

In step S306 the camera 112 captures images of the listener(s) 108. The soundbar 102 is a very well-suited place to implement a camera for capturing images of people since the soundbar 102 is usually positioned such that it has a good view of a room. For example, the soundbar 102 may be placed under or above the display 104 facing towards a usual listener location. The display 104 and the soundbar 102 are usually positioned so that they are viewable from positions at which the listener is likely to be located, which conversely means that the listener is usually viewable from the soundbar 102. The camera 112 may be any suitable type of camera for capturing images of the listener(s) 108. In some examples, the camera 112 may include a wide angle lens which allows the camera 112 to capture a wider view of the environment, thereby making it more likely that the captured images will include any listeners who are currently present. The camera 112 may capture visible light and/or infra-red light. As another example, the camera 112 may be a depth camera which can determine a depth field representing the distance from the camera to objects in the environment. For example, a depth camera may emit a particular pattern of infra-red light and then see how that pattern reflects off objects in the environment in order to determine the distances to the objects (wherein the emitted pattern may vary with distance from the depth camera).

Furthermore, two or more cameras may be used together to form a stereo image, from which depths in the image can be determined. Determining depths of objects in an image can be particularly useful for enabling accurate gesture recognitions. The camera 112 or the processing logic 202 may perform image processing functions (e.g. noise reduction and/or other filtering operations, tone mapping, defective pixel fixing, etc.) in order to produce an image comprising an array of pixels, e.g. in RGB format where a pixel is represented by a red, a green and a blue component. An image may be captured by the camera at periodic (e.g. regular) intervals. To give some examples, an image may be captured by the camera at a frequency of thirty times per second, ten times per second, once per second, once per ten seconds, or once per minute.

In step S308 the processing logic 202 analyses the captured images to determine at least one characteristic of the listener(s) 108. In order to do this the processing logic 202 analyses the image to determine how many listeners are present in the image. Techniques for detecting the presence of people in images are known to those skilled in the art and for conciseness the details of those techniques are not described in great detail herein.

The determined characteristic(s) of a listener 108 may for example be an age group of the listener 108 and/or a gender of the listener 108. For example, the processing logic 202 may implement a decision tree which is trained to recognize particular visual features of people who have particular characteristics, e.g. people in a particular age range or people of a particular gender. A listener's “characteristics” are inherent features of the listener which may be useful for categorising the listener into one of many different types of listener who may typically have different interests, requirements and/or preferences. For example, the processing logic 202 could categorise the listener 108 as falling into one of the age ranges: baby/toddler (e.g. approximately 0 to 2 years old), young child (e.g. approximately 3 to 7 years old), child (e.g. approximately 8 to 12 years old), teenager (e.g. approximately 13 to 17 years old), young adult (e.g. approximately 18 to 29 years old), adult (e.g. approximately 30 to 59 years old), and older adult (e.g. approximately 60 years old and older). As described herein, different content may be suitable for listeners of different age groups. As another example, the processing logic 202 could categorise the listener 108 as either male or female. Different content may be of interest to listeners of different gender. The categorization of the listener into one of the categories (e.g. age range or gender) may use a technique which analyses features of the listener's face (e.g. using a facial recognition technique) and/or body shape. People skilled in the art will know how such techniques could be used to analyse the images of the listener to determine characteristics of the listener 108, and for conciseness the details of such techniques (e.g. facial recognition) are not described herein.

In step S310 it is determined whether there is more audio content to be outputted from the soundbar 102. If there is no more audio content to be outputted from the soundbar 102 then the method ends at step S312. However, if there is more audio content to be outputted, which will be the case while a stream of audio content is being provided to the soundbar 102 and outputted from the speakers 110 in real-time, then the method passes from step S310 to step S314.

In step S314 the processing logic 202 controls the audio content outputted from the speakers 110 to the listener 108 based on the determined characteristic(s) of the listener 108. Furthermore, in examples in which the visual content is routed via the soundbar 102 then in step S314 the processing logic 202 may control the visual content that is passed to the display 104 for output therefrom based on the determined characteristic(s) of the listener 108. For example, if in step S308 it was determined that the listener is a young child (e.g. in an age range from approximately 3 to 7 years old) then the processing logic 202 might control the audio and/or video content by imposing age restrictions, e.g. so that swearing or other age-inappropriate audio and/or video content is not outputted to the listener 108. The method passes from step S314 back to step S304 and the method repeats for further audio content.

In the examples described above, there may be occasions when the processing logic 202 incorrectly determines that the listener has a particular characteristic (e.g. it may determine the approximate age of the listener incorrectly). Due to the variation in listeners' physical appearance it is difficult to ensure that the processing logic 202 would never incorrectly categorise the listener 108. One way to overcome this is to have a predefined content profile associated with a set of predefined listeners 108. For example, if the soundbar 102 is to be used in a family home, then each member of the family may be a predefined listener, such that each member of the family can have a personalised content profile. One or more of the predefined listeners (e.g. the parents of a family) may be allowed to change the content profiles for all of the set of predefined listeners (e.g. all of the family). The processing logic 202 can be trained to recognize the predefined listeners, e.g. by receiving a plurality of images of a listener with an indication of the identity of the listener 108. The processing logic 202 can then store a set of parameters describing features of the listener (e.g. facial features such as skin colour, distance between eyes, relative positions of eyes and mouth, etc.) which can be used subsequently to identify the predefined listeners in images captured by the camera 112. Methods for training a system to recognize predefined users in this manner are known in the art.

Once the content profiles of the set of predefined listeners 108 have been set up then the processing logic 202 can analyse the images captured by the camera 112 to determine the characteristics of the listener 108 by using facial recognition to recognize the listener 108 as one of the set of predefined listeners. The content profile of the recognized listener indicates the characteristics (e.g. preferences, interests, restrictions, etc.) of the listener 108. Provided that the facial recognition correctly identifies the listener 108 from the set of predefined listeners and provided that the content profile for the listener is correctly set up, then this method will accurately determine the characteristics of the listener 108. Therefore, the processing logic 202 can control the audio content outputted from the speakers 110 (and/or the video content outputted from the display 104) to the recognized listener 108 in accordance with the content profile of the recognized listener 108. The content profiles of the predefined listeners may be stored in the data store 204.

The content profile of a listener 108 indicates characteristics of the listener 108 and may comprise one or more of the attributes listed below.
1. The content profile of a listener 108 may comprise a volume range preferred by the listener 108. For example, a listener 108 may prefer louder than average audio content, e.g. if the listener 108 has hearing difficulties. As another example, a listener 108 may prefer quieter than average audio content, e.g. if the listener 108 has particularly sensitive hearing. The processing logic 202 may control the volume of the audio content outputted from the soundbar 102 in accordance with the recognized listener's preferred volume range.
2. The content profile of a listener 108 may comprise an audio style preferred by the listener 108. An audio style may for example comprise at least one of mono, stereo, surround sound or binaural audio formats. One listener 108 may like the effect of surround sound or binaural audio, whereas another listener 108 may prefer to hear audio content in a simpler audio format, e.g. as mono or stereo audio. The soundbar 102 can control the audio content so as to output the audio content according to the recognized listener's audio format of choice.
3. The content profile of a listener 108 may comprise a language that is preferred by the listener 108. For example, one listener 108 may understand English, and so all audio content is outputted to that listener 108 in English where possible. If the audio content is received at the soundbar 102 in a language other than the listener's preferred language then in some examples, the processing logic 202 performs an automatic translation of speech signals in the audio content to convert the language to the listener's preferred language before outputting the audio content. Automatic translation may be an optional feature which the listener can set in the content profile to indicate whether this feature is to be implemented or not. The content profile for a listener may be able to specify more than one language which the listener 108 can understand.
4. The content profile of a listener 108 may comprise a video style preferred by the listener 108. A video style specifies settings of how the video content is output from the display 104 and may for example specify at least one of an aspect ratio, a brightness setting, a contrast setting, a frame rate with which the video content is to be outputted from the display 104. As an example, one listener 108 may like an aspect ratio of 4:3, whereas another listener 108 may prefer an aspect ratio of 16:9. The soundbar 102 can control the video content before passing it to the display 104 such that the video content is output from the display 104 according to the recognized listener's video style of choice.
5. The content profile of a listener 108 may comprise one or more interests of the listener 108. In this case, the processing logic 202 may be able to tailor the audio content outputted from the speakers 110 to the listener 108 (and in some examples tailor the video content outputted from the display 104) in accordance with the listener's interests. This could be useful for advertisements, so that when the audio/video content is content of an advertisement then the content is chosen to match a listener's interests. For example, if the listener is interested in sports but not fashion then content for advertisements relating to sports may be outputted to the listener 108 rather than outputting content for advertisements relating to fashion.

6. The content profile of a listener 108 may comprise an age and/or gender of the listener 108. This allows the age and/or gender of the listener 108 to be determined precisely, rather than attempting to categorize the listener into an age range or gender based on their physical appearance as in examples described above. Different audio content and/or video content may be appropriate for listeners of different ages and/or genders so the soundbar 102 can control the audio content to output appropriate audio content to the listener 108 based on the age and/or gender of the listener 108. The soundbar 102 may control the video content which is passed to the display 104 based on the age and/or gender of the listener 108. For example, different advertisements may be outputted to listeners of different ages and/or genders. As another example, different restrictions (e.g. for restricting swear words or restricting some visual content) may be applied to audio and/or video content for listeners of different ages. The age of the listener 108 may be stored as a date of birth, rather than an age so that it can automatically update as the listener gets older. If age restrictions are detected and the content rating is known (e.g. from metadata in the content stream or alternatively via an automatic internet search using the title of the content, e.g. if the content is a known TV programme or film) then the soundbar 102 may prevent the output of the audio and/or video content. In this case, the soundbar 102 may generate an on screen display (OSD) to be displayed on the display 104 to alert the listener 108 why the content is being blocked. In the case that the age appropriateness of the audio content cannot be determined the processing logic 202 of the soundbar 102 may be able to process the audio content before it is output to detect inappropriate speech (e.g. profanities). If a child is in the audience then speech content beyond the watershed watchlist could be detected and muted or ‘beeped out’ or not outputted at all. Even if the camera 112 cannot detect the presence of a child, a listener 108 may be able to provide an input to the soundbar 102 (e.g. using a remote control) to indicate that a child is in the vicinity and that content should only be output if it is age-appropriate for the child.
7. The content profile of a listener 108 may comprise restrictions to be applied to audio and/or video content. For example, the parents of a family may impose restrictions on the types of audio and/or video content that can be outputted to each member of the family.

The content profile of a listener 108 may comprise other attributes (in addition to or as an alternative to the attributes listed above) which can be used to control audio content outputted from the soundbar 102 to the listener 108 and/or to control video content passed to the display 104 to be outputted to the listener 108.

As shown in FIGS. 1 and 2, the soundbar 102 is coupled to the display 104, and the display 104 is configured to output visual content in conjunction with the audio content outputted from the speakers 110 of the soundbar 102. The combination of the audio content and the visual content forms media content which can be provided to the listener 108. In some examples, the processing logic 202 may analyse the images captured by the camera 112 to detect a gaze direction of the listener 108 and to determine if the listener 108 is looking in the direction of the display 104. This can be useful for determining whether the listener 108 is engaged with the media content. The processing logic 202 may control the audio content outputted from the speakers 110 and/or the video content passed to the display 104 based on whether the listener is looking at the display 104. For example, if the listener 108 is not looking at the display 104 and has not looked at the display 104 for over a predetermined amount of time (e.g. over a minute) then the processing logic 202 may determine that the listener 108 is not engaged with the media content and may control the output of the content accordingly, e.g. to reduce the volume of the audio content.

If, on analysing the images captured by the camera 112, the processing logic 202 determines that a plurality of listeners 108 (e.g. listeners 108₁ and 108₂) are present, then audio content may be provided from the soundbar 102 to each of the listeners 108 in accordance with each of the their determined characteristics (e.g. in accordance with each of the their content profiles). For example, at least one characteristic of each of the plurality of listeners may be detected by analysing the images captured by the camera 112 and the processing logic 202 may control the audio content outputted from the speakers 110 and/or the video content passed to the display 104 based on the detected at least one characteristic of the plurality of listeners 108.

Some soundbars may be capable of beamsteering audio content outputted from the soundbar such that the audio content is provided in a particular direction from the soundbar 102. By analysing the images captured by the camera 112, the processing logic 202 can determine the direction to each of the listeners 108. The processing logic 202 can then direct beams of audio content to the detected listeners 108. The multiple beams of audio content may be the same as each other. However, it is possible to output multiple beams of audio content from a soundbar which are not the same as each other. Techniques for outputting different audio content in different directions from a soundbar are known in the art and for conciseness the details of such techniques are not described herein. Therefore, the processing logic 202 can control the soundbar 102 to output audio content to each of the listeners 108 which is tailored to the characteristics of each listener 108. That is, the processing logic 202 may separately control the audio content for different listeners 108.

As an example, as described above, the processing logic 202 can use facial recognition to recognize the plurality of listeners 108 as being listeners of a set of predefined listeners. Each listener of the set may have a predefined content profile. Therefore, the processing logic 202 may control the audio content outputted from the speakers 110 to each of the plurality of listeners 108 in accordance with their content profiles and may control the video content passed to the display 104 to be outputted to each of the plurality of listeners 108 in accordance with their content profiles. For example, different content (e.g. different advertisements) may be outputted to different listeners based on the listener's content profile. In one example, audio content for an advertisement for toys may be outputted to a listener who is a child whilst simultaneously audio content for an advertisement for music may be outputted to a listener who has music indicated as an interest in their content profile. As another example, different listeners may receive audio content at different volumes if the different listeners 108 have different preferred volume ranges stored in their content profiles. As another example, audio content may be outputted to a first listener 108₁ in a first audio style (e.g. in a binaural audio format) which is indicated in the first listener's content profile as a preferred audio style, while simultaneously audio content may be outputted to a second listener 108₂ in a second audio style which is different to the first audio style (e.g. in a stereo audio format) which is indicated in the second listener's content profile as a preferred audio style.

If, on analysing the images captured by the camera 112, the processing logic 202 determines that no listeners 108 are currently present and have not been present for a preset period of time, then the soundbar 102 and/or the display 104 may be placed into a low power mode to save power. The camera 112 may still be operational in the low power mode such that the soundbar 102 can determine when a listener 108 becomes present, in which case the soundbar 102 and/or display 104 can be brought out of the low power mode and return to an operating mode.

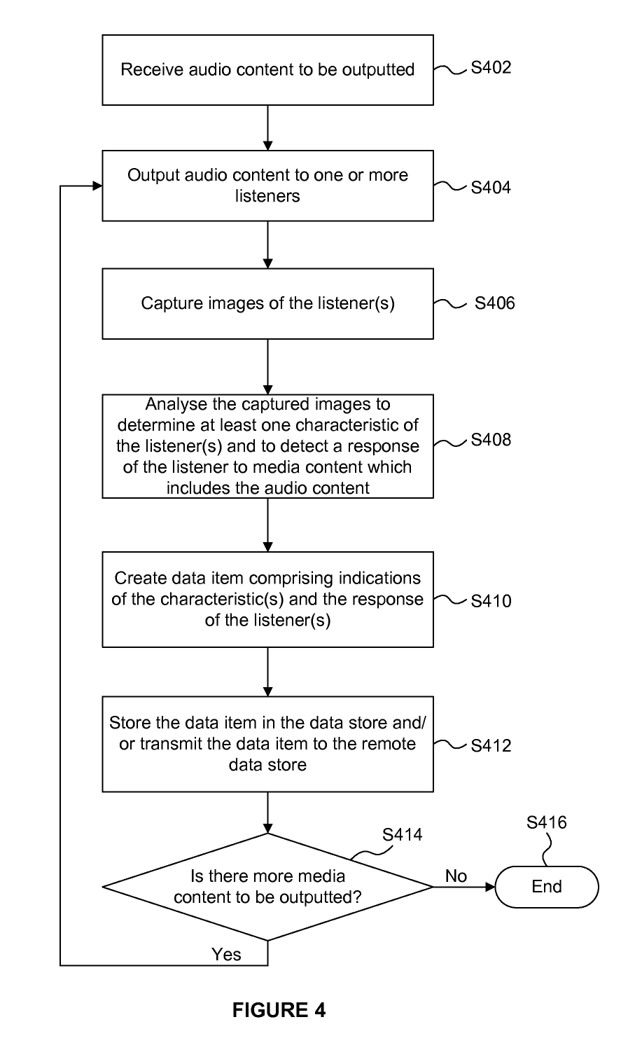

With reference to the flow chart shown in FIG. 4 there is now described a second method of operating the soundbar 102. Steps S402 to S406 are similar to corresponding steps S302 to S306. Therefore, in step S402 audio content is received at the soundbar 102 which is to be outputted from the speakers 110 of the soundbar 102. The audio content may be received, from the STB 106, at the I/O interface 206. The audio content may be received at the soundbar 102 to be outputted in conjunction with visual content outputted from the display 104. The visual content may, or may not, be passed to the display 104 via the soundbar 102.

In step S404 the audio content is outputted from the speakers 110 to the listener(s) 108.

In step S406 the camera 112 captures images of the listener(s) 108, in a similar manner to that described above in relation to step S306. In this way an image is provided which comprises an array of pixels, e.g. in RGB format where a pixel is represented by a red, a green and blue component.

In step S408 the processing logic 202 analyses the captured images to determine at least one characteristic of the listener(s) 108, e.g. the age or gender of the listener 108. This can be done as described above, and may for example involve identifying a listener 108 as one of a set of predefined listeners (e.g. using facial recognition) and accessing a content profile of the listener 108.

The analysis of the captured images is also used in step S408 to detect a response of the listener 108 to the outputted content, e.g. to the audio content outputted from the speakers 110 and/or to the video content outputted from the display 104. Detecting a response of the listener 108 may comprise detecting a mood of the listener. As an example, a mood of the listener can be detected in the captured images by using facial recognition to identify facial features of the listener 108 which are associated with particular moods. For example, facial recognition may be able to identify that the listener 108 is smiling or laughing which are features usually associated with positive moods, or facial recognition may be able to identify that the listener 108 is frowning or crying which are features usually associated with negative moods. As another example, body language of the listener may be analysed to identify body language traits associated with particular moods, e.g. shaking or nodding of the head.

In step S410 the processing logic 202 creates a data item comprising: (i) an indication of the determined at least one characteristic (e.g. age range, gender, interest and/or preferred language of the listener 108), and (ii) an indication of the detected response of the listener 108 to the media content (i.e. the outputted audio and/or video content). The data item therefore provides an indication as to how a particular type of listener (i.e. a listener with a particular characteristic) responds to a particular piece of media content.

In step S412 the data item may be stored in the data store 204 and/or transmitted from the soundbar 102 to the remote data store 212 in the internet 210, e.g. via an I/O interface 206 which allows the soundbar 102 to connect to the internet 210.

In step S414 it is determined whether there is more audio content to be outputted from the soundbar 102. If there is no more audio content to be outputted from the soundbar 102 then the method ends at step S416. However, if there is more audio content to be outputted, which will be the case while a stream of audio content is being provided to the soundbar 102 and outputted from the speakers 110 in real-time, then the method passes from step S414 back to step S404 and the method repeats for further content.

The data store 212 may gather information from many different sources relating to how different types of listeners respond to particular pieces of media content. This can be useful in determining how positively the media content is being received by different types of listener. For example, the media content may be associated with an advertisement and in this case the data item can be used to determine how well an advertisement is performing. For example, the remote data store 212 may store many data items relating to how well users respond to an advertisement for a particular product. If listeners who are in the target market for the particular product (e.g. if they have interests related to the particular product or if they are in the appropriate age range and gender for the particular product, as defined in their content profile) are generally responding well to the advertisement then it can be determined that the advertisement is performing well. It may be the case that some listeners who are not in the target market (e.g. listeners who are not in the appropriate age range or gender or do not have related interests, as defined in their content profile) do not respond well to the advertisement, but this might not be important in assessing the performance of the advertisement since the advertisement was not expected to engage these listeners. It can be appreciated that the combination of the indication of the characteristics of the listener and the indication of the response of the listener could be very useful to the producers of an advertisement campaign in determining the effectiveness of the advertisement on the target market. As an example, some music may be aimed at a target audience having a particular age range (e.g. teenagers) and methods described herein could be used to determine how well listeners in the particular age range respond to the advertisement. The response of listeners outside of this particular age range (e.g. people over the age of 60) might not be deemed to be relevant in determining how well the advertisement has performed.

As another example, the media content may be a news item. In this case the data item combining the response of the listener with the characteristic(s) of the listener can be used to determine how well different types of listener respond to different news stories. This may be useful for obtaining feedback on the news stories, e.g. if the news story relates to a political policy then feedback may be obtained to determine the response of different types of people to the political policy.

As another example, the media content may be an entertainment programme. In this case the data item combining the response of the listener with the characteristic(s) of the listener can be used to determine how well different types of listener respond to the entertainment programme. This may be useful for obtaining feedback on the entertainment programme, e.g. if the programme is a comedy programme then the amount of laughter of different types of listener can be recorded to thereby assess the performance of the programme, with reference to a particular target audience.

When the soundbar 102 is coupled to the display 104 as described above, which outputs visual content in conjunction with the audio content outputted from the speakers 110 of the soundbar 102, then the processing logic 202 can detect a response of the listener 108 by analysing the captured images to detect a gaze direction of the listener 108 and to determine if the listener 108 is looking in the direction of the display 104. The amount of time that the listener 108 spends looking at the display 104 may be an indication of how much the listener 108 is engaged with the media content. This information may be included in the data item to indicate the response of the listener 108 to the media content which comprises the audio content outputted from the soundbar 102 and the visual content outputted from the display 104.

When there are multiple listeners 108 present (e.g. listeners 108₁ and 108₂) then the processing logic 202 may detect a response of each of the listeners 108 to the media content outputted from the speakers 110 and/or from the display 104. The responses from the different listeners may be stored in different data items along with their respective characteristics.

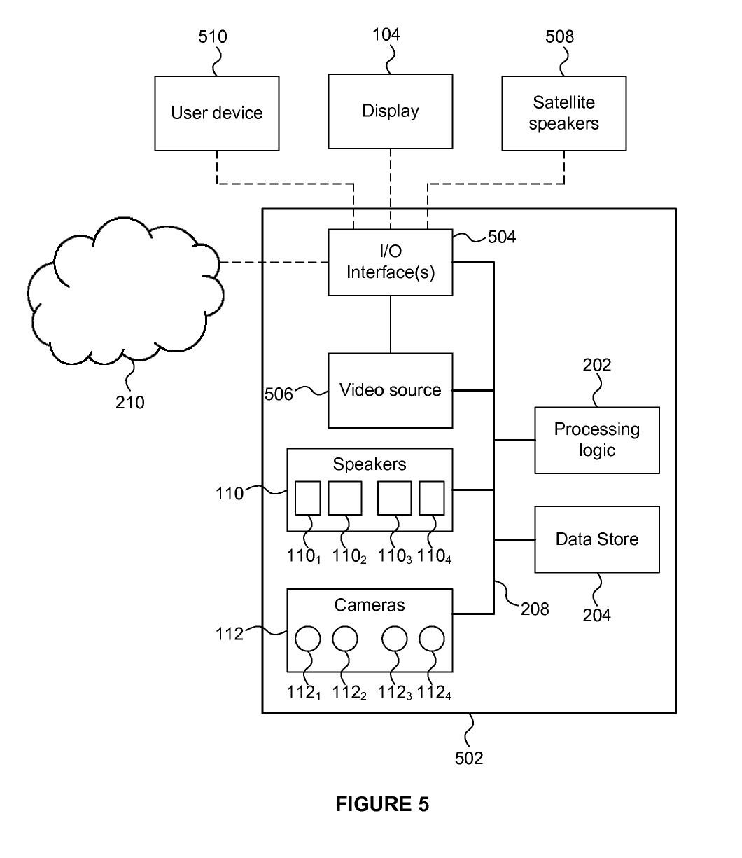

FIG. 5 shows a schematic view of some of the components of a soundbar 502 in another example. The soundbar 502 is similar to the soundbar 102 shown in FIG. 2 such that the soundbar 502 comprises the speakers 110, processing logic 202, a data store 204 and one or more Input/Output (I/O) interfaces 504 for communicating with other elements of a media system (e.g. for providing video content to the display 104 to be outputted therefrom). However, in contrast to the soundbar 102, the soundbar 502 includes multiple cameras 112₁, 112₂, 112₃ and 112₄ as well as a built-in video source 506. The video source 506 is configured to provide audio and video content to be outputted to the listener(s) 108, and may for example be a streaming video device, a STB or a TV receiver which can receive data via the I/O interfaces 504, e.g. over the internet 210. Having multiple cameras 112 (rather than a single camera) may allow images to be captured of a larger amount of the environment, which may therefore allow the soundbar 502 to identify listeners 108 which may be situated outside of the view of a single camera. Furthermore, the use of multiple cameras may allow stereo images to be captured for use in depth detection. The speakers 110, cameras 112, processing logic 202, data store 204, video source 506 and I/O interface(s) 504 are connected to each other via a communication bus 208.

The I/O interfaces 504 may comprise an interface for communicating with the display 104, and an interface for communicating over the internet 210. For example, the soundbar 502 may output data to be stored at a data store in the internet 210. Furthermore, the soundbar 502 may receive data from the internet 210, e.g. media content in the case that the media content to be outputted from the soundbar 502 and/or the display 104 is streamed over the internet. Furthermore, a sound system may comprise the soundbar 502 and one or more satellite speakers 508 which can be located separately around the environment to which the audio content is to be delivered. For example, the combination of the soundbar 502 and the satellite speakers 508 may form a surround sound system, e.g. where the satellite speakers 508 are the rear speakers of the surround sound system. The I/O interfaces 504 may comprise an interface for communicating with the satellite speakers 508 and the soundbar 502 may be configured to send audio content to the satellite speakers 508 to be outputted therefrom. In this way the soundbar 502 controls the audio content which is outputted from the satellite speakers 508 so that it combines well with the audio content outputted from the speakers 110 of the soundbar 502. Furthermore, a user (e.g. the listener 108) can control the soundbar 502 using a user device 510 which is connected to the soundbar 502 via the I/O interfaces 504. That is, the I/O interfaces 504 may comprise an interface for communicating with the user device 510. The user device 510 may for example be a tablet or smartphone etc. The connections between the I/O interfaces 504 of the soundbar 502 and the display 104, the internet 210, the satellite speakers 508 and the user device 510 may be wired or wireless connections according to any suitable type of connection protocol. For example, FIG. 5 shows these connections with dashed lines indicating that they are wireless connections, e.g. using WiFi or Bluetooth connectivity. It can be appreciated that the soundbar 502 includes most of the bulky components of a media system (such as the speakers 110 and the video source 506), and as such these components do not need to be included in the display 104. This allows more freedom in the design of the display 104, such that the capabilities of the display 104 are not limited by a need to include speakers and/or video processing modules. For example, this may allow the display 104 to be very thin, and possibly as display technology advances may allow the display 104 to be flexible. Furthermore, by using wireless connections between the soundbar 502 and the display 104, internet 210, satellite speakers 508 and user device 510, the system avoids the use of wires except for power connections, which can improve the design elegance of the system. The soundbar 502 can operate in a similar manner to that described above in relation to the soundbar 102, e.g. in order to use images captured by the camera(s) 112 to control media content outputted to a listener 108 and/or to detect a response of the listener 108 to media content.

In the examples described above the audio content may be part of media content (e.g. television content) which also comprises visual content which is outputted from the display 104 in conjunction with the audio content outputted form the soundbar 102. In other examples, the audio content might be outputted without having associated visual content, and the soundbar 102 might not be coupled to a display. This may be the case when the audio content is music content or radio content for which there is no accompanying visual content. As used herein, the term “audio content” thus applies to audio content that is associated with video content as well as audio content that is independent of any video or visual content.

In the examples described above the audio content provides media to the listener 108, e.g. a television broadcast or radio broadcast or music, etc. In other examples, the soundbars and methods described herein may be used for providing audio content of a teleconference call or a video conference call to the listener. In these examples, the audio content outputted from the soundbar 102 comprises far-end audio data from the far end of the call to be provided to the listener 108. The soundbar may be coupled to a microphone for receiving near-end audio signals from the listener 108 to be transmitted to the far-end of the call.

The examples described above relate to soundbars. Similar principles may be applied in other enclosures which comprise a plurality of speakers and a camera, such as speaker systems, televisions or other computing devices such as tablets, laptops, mobile phones, etc.

Generally, any of the functions, methods, techniques or components described above as being implemented by the processing logic 202 can be implemented in modules using software, firmware, hardware (e.g., fixed logic circuitry), or any combination of these implementations.

In the case of a software implementation, the processing logic 202 may be implemented as program code that performs specified tasks when executed on a processor (e.g. one or more CPUs or GPUs). In one example, the methods described may be performed by a computer configured with software in machine readable form stored on a computer-readable medium. One such configuration of a computer-readable medium is signal bearing medium and thus is configured to transmit the instructions (e.g. as a carrier wave) to the computing device, such as via a network. The computer-readable medium may also be configured as a non-transitory computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The software may be in the form of a computer program comprising computer program code for configuring a computer to perform the constituent portions of described methods or in the form of a computer program comprising computer program code means adapted to perform all the steps of any of the methods described herein when the program is run on a computer and where the computer program may be embodied on a computer readable medium. The program code can be stored in one or more computer readable media. The features of the techniques described herein are platform-independent, meaning that the techniques may be implemented on a variety of computing platforms having a variety of processors.

Those skilled in the art will also realize that all, or a portion of the functionality, techniques or methods described as being performing by the processing logic 202 may be carried out by a dedicated circuit, an application-specific integrated circuit, a programmable logic array, a field-programmable gate array, or the like. For example, the processing logic 202 may comprise hardware in the form of circuitry. Such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnects, by way of example. Such elements may be provided as custom circuits or standard cell libraries, macros, or at other levels of abstraction. Such elements may be interconnected in a specific arrangement. The processing logic 202 may include circuitry that is fixed function and circuitry that can be programmed to perform a function or functions; such programming may be provided from a firmware or software update or control mechanism. In an example, hardware logic has circuitry that implements a fixed function operation, state machine or process.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood that the benefits and advantages described above may relate to one example or may relate to several examples.

Any range or value given herein may be extended or altered without losing the effect sought, as will be apparent to the skilled person. The steps of the methods described herein may be carried out in any suitable order, or simultaneously where appropriate. Aspects of any of the examples described above may be combined with aspects of any of the other examples described to form further examples without losing the effect sought.

1. A soundbar comprising:
a plurality of speakers configured to output audio content to a listener;
a camera configured to capture images of the listener; and
processing logic configured to:
(i) analyse the captured images to determine at least one characteristic of the listener; and
(ii) control the audio content outputted from the speakers to the listener based on the determined characteristic of the listener.

2. The soundbar of claim 1 wherein the at least one characteristic of the listener comprises at least one of an age group of the listener and a gender of the listener.

3. The soundbar of claim 1 wherein the processing logic is configured to analyse the captured images to determine at least one characteristic of the listener by using facial recognition to recognize the listener as one of a set of predefined listeners.

4. The soundbar of claim 3 wherein each of the set of predefined listeners is associated with a content profile, wherein the processing logic is configured to control the audio content outputted from the speakers to the recognized listener in accordance with the content profile of the recognized listener.

5. The soundbar of claim 4 wherein the content profile of a listener comprises at least one of:
(i) a volume range;
(ii) an audio style;
(iii) a language;
(iv) a video style;
(iv) one or more interests of the listener;
(v) an age;
(vi) a gender; and
(vii) restrictions to be applied to audio content.

6. The soundbar of claim 1 wherein the soundbar is coupled to a display which is configured to output visual content in conjunction with the audio content outputted from the speakers of the soundbar.

7. The soundbar of claim 6 wherein the soundbar is configured to provide the visual content to the display for output therefrom, wherein the processing logic is further configured to control the visual content provided to the display for output to the listener based on the determined at least one characteristic of the listener.

8. The soundbar of claim 7 wherein the processing logic is configured to:
analyse the captured images to detect a gaze direction of the listener and to determine if the listener is looking in the direction of the display; and
control at least one of: (i) the audio content outputted from the speakers, and (ii) the visual content provided to the display, based on whether the listener is looking at the display.

9. The soundbar of claim 1 wherein the processing logic is configured to analyse the captured images to:
determine that a plurality of listeners are present,
detect at least one characteristic of each of the plurality of listeners, and
control the audio content outputted from the speakers based on the detected at least one characteristic of the plurality of listeners.

10. The soundbar of claim 9 wherein the processing logic is configured to separately control the audio content for different listeners.

11. The soundbar of claim 4 wherein the processing logic is configured to separately control the audio content for different listeners, and wherein the processing logic is configured to:
use facial recognition to recognize the plurality of listeners as listeners of the set of predefined listeners; and
control the audio content outputted from the speakers to each of the plurality of listeners in accordance with their content profiles.

12. A method of operating a soundbar comprising:
outputting audio content to a listener from a plurality of speakers of the soundbar;
capturing images of the listener using a camera;
analysing the captured images to determine at least one characteristic of the listener; and
controlling the audio content outputted from the speakers of the soundbar to the listener based on the determined at least one characteristic of the listener.

13. A soundbar comprising:
a plurality of speakers configured to output audio content to a listener;
a camera configured to capture images of the listener; and
processing logic configured to analyse the captured images to determine at least one characteristic of the listener and to detect a response of the listener to media content which includes audio content outputted from the speakers.

14. The soundbar of claim 13 wherein the processing logic is configured to create a data item comprising: (i) an indication of the determined at least one characteristic, and (ii) an indication of the detected response of the listener to the media content.

15. The soundbar of claim 14 further comprising a data store configured to store the data item.

16. The soundbar of claim 14 further comprising an interface configured to enable the data item to be transmitted from the soundbar over the internet to a remote data store.

17. The soundbar of claim 13 wherein the processing logic is configured to analyse the captured images to detect a response of the listener to media content which includes audio content outputted from the speakers by detecting a mood of the listener by either: (i) using facial recognition to identify facial features associated with particular moods, or (ii) analysing body language of the listener to identify body language traits associated with particular moods.

18. The soundbar of claim 13 wherein the media content is associated with: (i) an advertisement, (ii) a news item, or (iii) an entertainment programme.

19. The soundbar of claim 13 wherein the media content further includes visual content, and wherein the soundbar is coupled to a display which is configured to output the visual content in conjunction with the audio content outputted from the speakers of the soundbar, and wherein the processing logic is configured to detect a response of the listener by analysing the captured images to detect a gaze direction of the listener and to determine if the listener is looking in the direction of the display.

20. The soundbar of claim 13 wherein the processing logic is configured to analyse the captured images to:
determine that a plurality of listeners are present,
detect at least one characteristic of each of the plurality of listeners, and
detect a response of each of the plurality of listeners to the media content which includes the audio content outputted from the speakers.
